(19) United States
(12) Patent Application Publication
(10) Pub. No.: US 2005/0171797 A1
(43) Pub. Date: Aug. 4, 2005

(54) Intelligent access control and warning system for operations management personnel

(75) Inventor: Shawn Gregory Abigail, Kanata (CA)

Correspondence Address: KRAMER & AMADO, P.C., 2001 JEFFERSON DAVIS HWY, SUITE 1101, ARLINGTON, VA, 22202, US

(73) Assignee: Alcatel, Paris (FR)

(21) Appl. No.: 10/770,424

(22) Filed: Feb. 4, 2004

(51) Int. Cl. G06F 17/60

(52) U.S. Cl. 705/1

(57) ABSTRACT

A method of informing operations management personnel of the impact of an operations management action about to be performed is presented. Responsive to a request for the operations management action to be performed, a logic module ascertains the real world impact the operations management action will have when performed, and an informative message is formulated. In ascertaining the impact the operations management action, the logic module queries at least one managed entity roster tracking currently provisioned services and/or transactions, client lists, policies, etc. The formulated message is displayed to operations management personnel in obtaining confirmation of the request to perform the operations management action. Implementations of the logic module relate to network management systems, system management systems, transaction management system, transaction clearance systems, as well as to service provisioning applications. Advantages are derived from an informed decision making in respect of the real world impact assessment provided in real-time in connection with requesting each operations management action to be performed, and a finer granularity of control over operations management actions to be performed by operations management personnel.

### FIELD OF THE INVENTION

The invention relates to communications infrastructure and services management, and in particular to operations management personnel warning methods in support of intelligent operations management access control.

### BACKGROUND OF THE INVENTION

In the field of communications operations management which include, but is not limited to: communications network management, communications systems management, and service provisioning Network Management Systems (NMS), Element Management Systems (EMS), and service provisioning software, are employed respectively to perform a variety of tasks including, but not limited to: commissioning/decommissioning communications infrastructure, commissioning/decommissioning services over the communications infrastructure, modifying communications infrastructure and provisioned service operational parameters, reporting, etc.

Operations management is becoming ever more complex due to a continuing adoption of new technologies and therefore it is an unreasonable expectation for operations management personnel to be aware at all times, and in all circumstances, of the impact a particular operations management action may have. Unfortunately a trend is being observed pointing out a correlation between an increasing operations management complexity and increasing costs incurred by service providers and customers due to experienced network/service outage. Large fractions of cost overheads are found to be incurred, at least in part, due to the fact that operations management personnel was not fully aware of the impact of operations management actions taken.

For example, the number of customer service connections provisioned via a physical communications link or a high level logical content transport tunnel is not provided operations management personnel in servicing the physical communications link or the high level logical content transport tunnel. A very large number of customers may be affected if a high bandwidth physical communications link or a high bandwidth high level content transport tunnel were taken out of service. Typically high level logical content transport tunnels have an associated signaling channel for connectivity management. Decommissioning the associated signaling channel leaves the high level logical content transport tunnel, and all content traffic conveyed therethrough, unmanaged. As another example, the amount of time required to recover a communications network node is not provided to operations network management personnel resetting the communications network node being serviced. As core communications network nodes are characterized by high throughput densities, lengthy reset times therefore lead to large numbers of connections experiencing network unavailability. Bringing down a Domain Names Service (DNS) server, blocks further connection establishment in an Internet Protocol communications network while established connections continue to convey content. As a further example, without actually experiencing a network outage, deleting an entire “hosts deny” filter rule list on a gateway would lead to severe security implications wherein a failover from a secure network to an insecure network will be experienced.

While the above examples may intuitively be understood by highly trained and experienced operations management personnel, even good intentions could lead to undesirable network performance and network unavailability. As an example, in a service provisioning environment, performing reporting, such as billing, during peak operation time periods could affect service provisioning potentially violating Service Level Agreements due to an intensive access to a client database blocking other operations and potentially blocking customer transactions. As another example, a failover from a secure network to an insecure network may result from well intended innocent commissioning of an additional load balancing link/trunk directly between a public communications network and a private communications network without traversing a firewall/proxy.

In accordance with a current typical interaction between a operations management personnel and a management system and/or software implementing functionality provisioned thereon, individual operations management persons (operators) are granted certain levels of permissions to perform specific operations management actions in an exemplary operations management context. Such span of control is based on individual login identifiers corresponding to operations management personnel. For example, at least one operator having the highest permission level “super user” can execute any operations management action, multiple other operators, having lower permission levels, may only execute fewer and less service affecting operations management actions, respectively. The lowest permission level would be ascribed to an entry level operator and would for example permit the entry level operator to create/establish a content transport tunnel/path, yet permission to delete/tear-down a content transport tunnel/path would not be granted.

Problems with the current approach is experienced regardless of the training and experience of a particular operator. Even though the operator has the requisite certified training and permission to perform operations management actions at a certain level, the operator may not be knowledgeable of the impact on provisioned services, on infrastructure, and/or on resources a given operations management action may have in a particular situation. In respect of system management in a telecommunications context, a particular operator cleared for decommissioning physical links, may decommission a T1/E1 link potentially affecting 24/32 provisioned DS0 services; the same permission clearing the operator to decommission an OC-192 link potentially affecting 129,024 provisioned DS0 services. The only safeguard currently provided against critical service-affecting operations management actions is the well-known request confirmation presented to operators interacting with the management system via an interface which basically asks ‘Are you sure?’ which is typically regarded by operators just as an annoying delay and automatically answered affirmatively. More troubling, is the fact that typically such confirmation message windows automatically have the affirmative choice preselected!

There therefore is a need to solve the above mentioned issues.

### SUMMARY OF THE INVENTION

In accordance with an aspect of the invention, an intelligent management system ascertaining the real world impact of an operations management action to be performed is provided. The intelligent management system includes a logic module responsive to a request for performing the operations management action. The logic module queries a managed entity roster, determines the real world impact of the operations management action about to be performed, and formulates a request confirmation message stating the determined impact.

In accordance with another aspect of the invention, a method of providing a real world impact in respect of an operations management action about to be performed is provided. The method includes determining the real world impact of the operations management action about to be performed in response to a request for performing the operations management action. A request confirmation message stating the real world impact is formulated.

In accordance with a further aspect of the invention, the method further includes displaying the confirmation request message informing of the real world impact of the operations management action to be performed to operations management personnel.

In accordance with a further aspect of the invention, the method further includes selectively denying the request for performing the operations management action based on the determined impact.

In accordance with yet another aspect of the invention, the method further includes selectively denying the request for performing the operations management action based on a combination of the determined impact and a permission level of the operator requesting the operations management action to be performed.

Advantages are derived from an informed decision making in respect of the real world impact assessment provided in real-time in connection with requesting each operations management action to be performed, and a finer granularity of control over operations management actions to be performed by operations management personnel.

### BRIEF DESCRIPTION OF THE DRAWINGS

The features and advantages of the invention will become more apparent from the following detailed description of the exemplary embodiment(s) with reference to the attached diagrams wherein:

FIG. 1 is a schematic diagram showing exemplary elements implementing an exemplary intelligent management system and components of an exemplary intelligent service management software application providing an impact assessment in accordance with an exemplary embodiment of the invention; and

FIG. 2 is a flow diagram showing process steps in providing, in accordance with the exemplary embodiment of the invention, an intelligent impact assessment in respect of an operations management action to be performed.

It will be noted that in the attached diagrams like features bear similar labels.

### DETAILED DESCRIPTION OF THE EMBODIMENTS

Information regarding the impact a given operations management action would have in a particular situation is not readily apparent nor readily available even if the operator wanted to determine the impact before executing the operations management action.

In accordance with an exemplary embodiment of the invention, should operations management action impact information be available to operations network management personnel, a different or delayed operations management action may be taken to avoid negatively affecting communications network infrastructure, services, and customers, thereby reducing related overhead operations management costs.

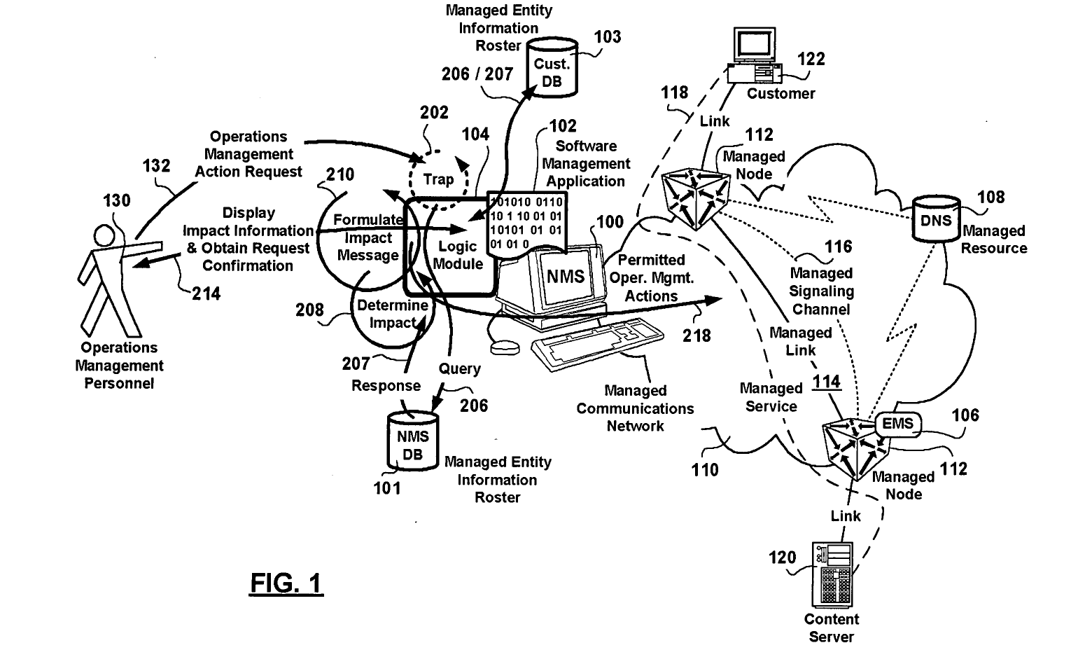

FIG. 1 is a schematic diagram showing exemplary elements implementing an exemplary intelligent management system 100 and components of an exemplary intelligent service management software application 102 providing an impact assessment in accordance with the exemplary embodiment of the invention.

In accordance with the exemplary embodiment of the invention, the management system (100) includes a logic module 104 determining 208 and presenting 214 operations management personnel with action-related impact information in connection with obtaining confirmation for operations management actions to be performed. Although the invention will be described herein below in respect of communications network management in a managed communications network 110, the invention is not limited thereto, other management systems (100) including, but not limited to: Network Management Systems (NMS) 100, Element Management Systems EMS 106, information management systems 108, security management systems, service provisioning systems, online transaction management systems, transaction clearance management systems, etc. may also implement a logic module (104) determining 208 and presenting 214 operations management personnel with action-related impact information in interacting therewith.

In accordance with the exemplary embodiment of the invention, service provisioning management software application 102 includes a logic module 104 determining 208 and presenting 214 operations management personnel with action-related impact information in connection with obtaining confirmation for operations management actions to be performed. Although the invention will be described herein below in respect of service provisioning in a managed communications network, the invention is not limited thereto, other software applications including, but not limited to: accounting, billing, reporting, statistics generation, security, transaction management, transaction clearance, etc.

In the context of a communications network management, a logic module 104 associated with a network management system 100 queries a network management database 101 tracking a containment hierarchy of managed entity instances in the managed communications network 110 including, but not limited to: physical links 114, network nodes 102, shelves, interface cards, ports, trunks, logical links 114, logical ports, virtual routers, content transport tunnels 118, managed service connections 118, managed signaling channels 116, network management policies, etc. In a service provisioning context, a logic module 104 associated with a software service management application 102 may also query a customer database 103 tracking customer lists, service policies, customer Service Level Agreements, etc. Service/Network policies may include schedule maintenance period specifications.

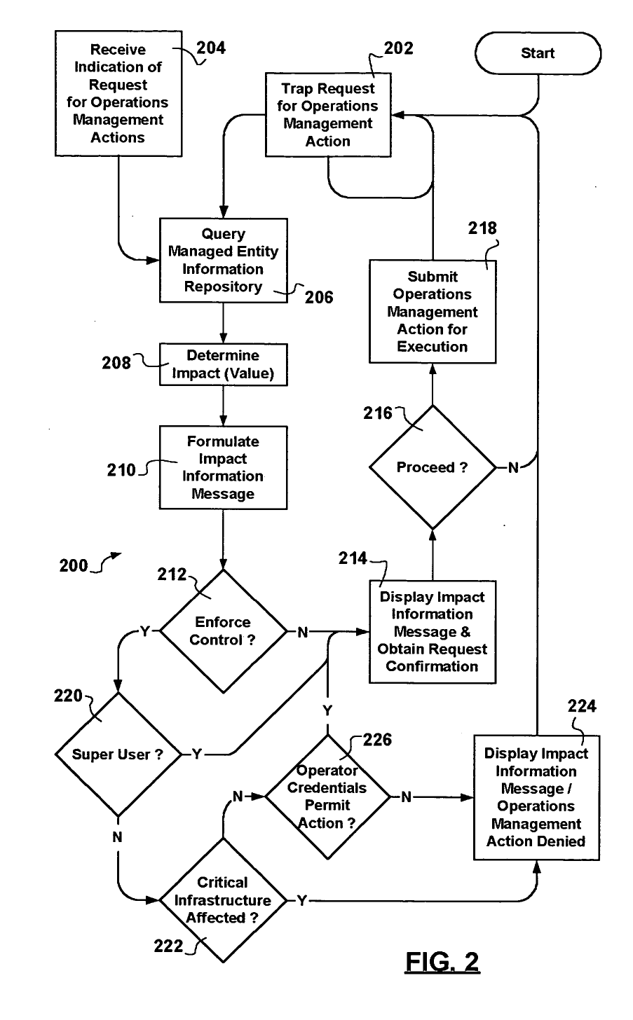

FIG. 2 is a flow diagram showing process steps in providing, in accordance with the exemplary embodiment of the invention, an intelligent impact assessment in respect of an operations management action to be performed.

In accordance with an implementation of the exemplary embodiment of the invention, the logic module 104 traps 202 operations management actions execution requests 132, queries 206 a management information roster 101 based on each the operations management action 132 to be performed for impact related information, obtains 207 impact related information, optionally computes an impact level in determining 208 of the impact, formulates 210 a request confirmation message stating the determined corresponding real world impact, and optionally restricts (212) performing the operations management action based on the determined impact level (222) and optionally based on the operator's access level/qualifications 226. An operations management action request confirmation message is displayed informing the operator of the consequences of the action if committed.

In accordance with the exemplary embodiment of the invention, employing a logic module 104 to determine 204 and to present 214 operations management personnel with impact information in respect of requested action execution, makes operations management personnel aware consequences respective actions will have before such operations management actions are performed (see “N” branch of step 212).

The logic module 104 determines 208 in real-time the impact a particular operations management action will have in response to a request 132 for performing the action. Accordingly, the operator 130 will be presented 214 with an impact informing message in requesting confirmation of the request to perform the operations management action such as, but not limited to: “17,345 subscribers will experience loss of service for 5 minutes! Do you wish to continue?” just as the operations management action is about to be performed. In a service provisioning management context, an exemplary confirmation request would ask: “143 separate SLA agreements will be violated during the remote access server reboot! Do you wish to continue with the reboot?” In an electronic transaction processing management context, an exemplary confirmation request would ask: “Deletion of the end-of-day report, if not backed-up, results in the loss of 1,752,983 financial transaction traces. Continue?” In an information management context, an exemplary confirmation request might ask: “73 files from a secure access location are to be copied to a public access location. Proceed?” Such warning messages 214 regarding real-world impact of various operations management actions do not by themselves necessarily enforce access control over operations management actions 212, rather such management systems provide immediate intelligent feedback in assisting even experienced operations management personnel to make informed decisions. Management personnel benefits from being made aware of the specific impact leading to a reduced number of outages and reduced incurred costs typically caused by human error, insufficient training and/or experience, inattentiveness, etc. Setting the default selection to “No” would also trade annoyance for increased safety.

In accordance with the exemplary embodiment of the invention, an aggregate impact value/level may be determined 208 based on several types of impact exemplary categorized such as, but not limited to: network impact, critical infrastructure impact, service(s) impact, customer impact, security impact, etc. Within each category there may be different subtypes of impact, for example:
Network impact:
   i. Size of the network: number of nodes and/or number of paths affected;
   ii. Severity of impact: outage, degradation, re-routable, etc.;
   iii. Network becoming unmanaged;
   iv. Duration of impact;
Critical resource (911) impact:
   i. Infrastructure affected;
   ii. Unavailability of standby, hot standby, redundant infrastructure;
   iii. Duration of impact;
Security impact:
   i. Infrastructure and services exposed;
   ii. Level of security breach, implications;
   iii. Duration of impact;
Service impact:
   i. Type of service: best-effort (IP), committed bit rate (ATM), 911, etc.;
   ii. Number of customers;
   iii. Duration of impact;
   iv. Severity of impact: outage, degradation, unmanaged, etc.;
Customer impact:
   i. Limited to customer Quality-of-Service (QoS) classes;
   ii. Number of customers;
   iii. Duration of impact;
   iv. Severity of impact: outage, degradation, unmanaged, etc.;
   v. Limited to provisioning new subscribers.

In accordance with the exemplary embodiment of the invention, permissions are granted (see “Y” branch at step 212) to operations management personnel 130 based on the impact a particular operations management action 132 will have in a given situation.

For example, an operator 130 may be allowed to decommission a communications network node 112 if no active content transport tunnels 114 are currently being provisioned, and prevented in step 226 if there is at least one active content transport tunnel 114. The operator 130 would however be able to decommission the communications network node 112 irrespective of a then current best-effort traffic throughput conveyed via the communications network node 112 which would be rerouted, by design, albeit incurring a small delay. As another example, operator 130 may not be allowed to perform operations management actions on critical infrastructure equipment provisioning 911 services, nor on 911 service reserved content transport paths, while being able to effect full control otherwise, as shown at step 222.

In accordance with the exemplary embodiment of the invention, a determined impact (step 208) may also be compared 226 to a permission level granted to the particular operator 130. If the determined level of impact (208) is within a range associated with the permission level granted to the operator, then permission to perform the action 132 is granted, following the “Y” branch of step 226, and the requisite action may be submitted for execution in step 218.

In accordance with an exemplary implementation, an operator 130 is given permission to perform operations management actions based on a weighted impact value determined in accordance with a predetermined set of rules. For example, a novice operator may be granted permission to perform actions of “an impact of 17 points or less” where: 2 points of impact are assigned to each medium sized customer, 10 points to each large customer, 20 points if the action would cause an outage that caused a Service Level Agreement (SLA) non-compliance for any “Gold Class” customer, etc. Such an operations management action access control (212) would prevent novice operations from performing certain operations management actions 132 even if the impact is understood, thereby leading to fewer network/service outages and therefore to reduced operations management overhead costs. Such stringent access control may be relaxed during scheduled maintenance windows.

The embodiments presented are exemplary only and persons skilled in the art would appreciate that variations to the above described embodiments may be made without departing from the spirit of the invention. The scope of the invention is solely defined by the appended claims.

1. A management system comprising:
a. a human-machine interface enabling an operator to interact therewith in submitting a request for an operations management action to be performed;
b. a managed entity roster tracking at least one managed entity; and
c. a logic module querying the managed entity roster, in connection with the request for the operations management action to be performed on the at least one managed entities, to determine and provide an indication as to the impact the operation management action would have in performing thereof.

2. The management system claimed in claim 1, further comprising one of a network management system, an element management system, an information management system, a service provisioning management system, a security management system, and a transaction management system.

3. The transaction management system claimed in claim 2, further comprising one of: an online transaction management system, and a transaction clearance management system.

4. The information management system claimed in claim 2, further comprising one of: a database management system, and a Lightweight Directory Access Protocol (LDAP) repository management system.

5. The management system claimed in claim 1, wherein the management roster further comprises one of: network management database tracking managed entities, a client database tracking customer profiles, a transaction database tracking transactions, a service level agreement repository tracking customer service contracts, a policy repository, and operator permissions.

6. A service provisioning application comprising:
a. a human-machine interface enabling an operator to interact therewith in submitting a request for an operations management action to be performed;
b. a managed entity roster tracking information in respect of at least one managed entity; and
c. a logic module querying the managed entity database, in connection with the request for the operations management action to be performed on the at least one managed entities, to determine and provide an indication as to the impact the operation management action would have in performing thereof.

7. The management system claimed in claim 6, wherein the management roster further comprises one of: network management database tracking managed entities, a client database tracking customer profiles, a transaction database tracking transactions, a service level agreement repository tracking customer service contracts, a policy repository, and operator permissions.

8. A method of providing an impact indication in performing an operations management action comprising the steps of:
a. obtaining an indication of the operations management action to be performed;
b. ascertaining the real world impact of the operations management action to be performed; and
c. formulating an informative message detailing the real world impact in performing the operations management action.

9. The method as claimed in claim 8, wherein obtaining the indication the method further comprises a step of: trapping the operations management action to be performed.

10. The method claimed in claim 8, wherein obtaining the indication the method further comprises a step of: receiving an indication of the operations management action to be performed.

11. The method claimed in claim 8, wherein ascertaining the real world impact of the operations management action, the method further includes querying a managed entity roster.

12. The method claimed in claim 8, further comprising a step of: displaying the informative message to operations management personnel in connection with obtaining confirmation of the request for the operations management action to be performed, the operations management personnel thus being able to make a informed decision in requesting the operations management actions to be performed.

13. The method claimed in claim 12, further comprising a step of: allowing the request for performing the operations management action subsequent to receiving an informed confirmation to proceed based on the displayed message stating the real world impact of the operations management action.

14. The method claimed in claim 8, further comprising a step of: selectively denying the operations management action request based on the real world impact ascertained.

15. The method claimed in claim 14, wherein ascertaining the real world impact of the operations management action, the method further comprising a step of:
determining an impact level.

16. The method claimed in claim 15, further comprising a step of: determining an impact type from: a network impact, a service impact, and a customer impact.

17. The method claimed in claim 16, further comprising a step of: weighting each impact type.

18. The method claimed in claim 14, wherein the step of selectively denying the operations management action request based on the real world impact ascertained is relaxed during periods of scheduled maintenance.

19. The method claimed in claim 8, further comprising a step of: selectively denying the operations management action request based on a combination of the real world impact ascertained and the span of control of the individual operator which submitted the operations management action to be performed.

20. The method claimed in claim 19, further comprising a step of: selectively denying the operations management action request submitted in respect of: a 911 service provisioning equipment, and a 911 provisioned service connection.

21. The method claimed in claim 19, wherein the step of selectively denying the operations management action request based on the real world impact ascertained is relaxed during periods of scheduled maintenance.
